(19) United States
(12) Patent Application Publication
(10) Pub. No.: US 2013/0162761 A1
(43) Pub. Date: Jun. 27, 2013

(54) ROTARY IMAGE GENERATOR

(71) Applicant: Raul Goldemann, Giv'atayim (IL)

(72) Inventor: Raul Goldemann, Giv'atayim (IL)

(21) Appl. No.: 13/819,705

(22) PCT Filed: Aug. 31, 2011
(86) PCT No.: PCT/IL2011/000701

§ 371 Date: Feb. 27, 2013

Related U.S. Application Data
(60) Provisional application No. 61/378,401, filed on Aug. 31, 2010.

(51) Int. Cl. H04N 5/232

(52) U.S. Cl. CPC H04N 5/23238
USPC 348/36

(57) ABSTRACT

A rotary system and method for capturing images and displaying moving images of the surroundings by rotating a camera in high speed and capturing a plurality of still images per second. The still images are then processed in real time and displayed in one or more display units. Each display unit can display a moving images view of a region in the surroundings and/or still images. Any still or moving image can be zoomed in.

### TECHNICAL FIELD

The present invention relates to image capture in general, and in particular to capturing, generating and displaying moving images surrounding a rotary image generator.

### BACKGROUND ART

Video cameras are the common tool to use for capturing moving images. A video camera can capture images of the same location over a period of time, when the camera is still. Alternatively, the camera can be moved in a sweeping motion in order to capture images of different areas (an action commonly referred to as “panning”). If the panning motion is too quick or abrupt, the captured images quality frequently degrades and the image becomes blurred or fuzzy.

Certain applications or circumstances such as surveillance cameras or military vehicles require capturing images in real time of the entire surroundings, for example a 360 degrees view, referred to herein as “panoramic view” or “360 degrees view”, around the camera location. A single video camera is unable to produce clear images in real time of the entire 360 degrees area surrounding the camera. In order to capture usable video images of 360 degrees and display them (on multiple displays) one would need today multiple, fixed video cameras or omni-directional systems.

### SUMMARY OF INVENTION

It is an object of the present invention to provide a system and method for capturing spherical moving images.

It is another object of the present invention to provide a system and method for capturing moving images and displaying them on one or more display devices in real time.

It is a further object of the present invention to provide a system and method for capturing full spherical moving images and displaying them on one or more display devices in real-time or substantially real-time.

The present invention relates to a rotary system for capturing images of the surroundings, comprising:

(i) a camera comprising one or more image sensors, one or more image sensor engines and one or more lenses for capturing a plurality of still images per second;

(ii) an image buffer for the captured plurality of still images;

(iii) a rotary connected to the camera for rotating the camera around its axis;

(iv) a controller unit for controlling the rotary's rotation speed and for controlling the camera's image capture; and

(v) a display unit for processing and displaying in real time the captured images in said image buffer,

wherein, the rotating camera takes a plurality of still images, each still image taken in a predetermined view angle and stored in said image buffer, such that the display unit can display from the images in the image buffer one or more views of the surrounding in a moving images view.

In some embodiments, the images captured in one rotation of the rotary system cover the entire panorama of the surroundings in a field of view of 360 degrees vertically by up to 360 degrees horizontally.

In some embodiments, every image captured overlaps with the previously captured image.

In some embodiments, every image captured overlaps by 5% or less with the previously captured image.

In some embodiments, every image captured does not overlap with the previously captured image.

In some embodiments, placing the images taken side by side in chronological order, produces in real time a panoramic view of the surroundings after compensating for overlaps in sequential image captures.

In some embodiments, the series of still images taken with a plurality of view angles, are displayed on one or more display devices.

In some embodiments, the rotary rotates with variable rotation speeds.

In some embodiments, the camera or the rotary or both can tilt.

In some embodiments, the camera or the rotary or both can tilt upwards, downwards or in any angle.

In some embodiments, the display unit can also display still images.

In some embodiments, wherein the display unit enables to zoom in a still image or a stream of moving images.

In some embodiments, the image buffer resides in a video card, the camera, the controller, the display unit or any combination thereof.

In some embodiments, the image buffer is a transfer link (such as data link or optical link) communicating directly between the camera and display unit.

In some embodiments, the system further comprises a permanent storage for saving the captured images.

In some embodiments, the display unit can perform search and retrieval operations using the saved images in the permanent storage, and process any array of stored images into moving images and/or spherical moving images.

In some embodiments, the search and retrieval operations comprise: pausing a moving image sequence, resuming to real time viewing, rewinding a moving image sequence, advancing a moving image sequence or any combination thereof.

The present invention further relates to a rotary method for capturing moving images of the surroundings, the method comprising the steps of:

(i) capturing a plurality of still images per second by a camera comprising one or more image sensors, one or more image sensor engines and one or more lenses;

(ii) holding said plurality of still images in an image buffer;

(iii) connecting the camera to a rotary for rotating the camera around its axis;

(iv) controlling the rotary's speed and controlling the camera's image capture by a controller unit; and

(v) processing and displaying the captured images by a display unit,

wherein, the rotating camera takes a plurality of still images, each still image taken in a predetermined view angle and held in said image buffer such that the display unit can display in real time one or more views of the surrounding in a moving images view.

### BRIEF DESCRIPTION OF DRAWINGS

FIG. 1 shows an embodiment of a rotary image generator of the invention.

FIGS. 2A-2D show four examples of a miniature standalone system. The rotating platform is inside an outer case which can be fixed to an asset or vehicle. FIG. 2A shows a system with a single camera; FIG. 2B shows a system with a single camera, wherein the camera is tilted; FIG. 2C shows a system with a two cameras, one for day capture and one for night capture; FIG. 2D shows a system with a two cameras, wherein the cameras are tilted.

FIG. 3 shows 100 images captured in 10 rotations, wherein each row shown the different images captured in that rotation, and each column shows images of the same view angle taken in different rotations.

FIG. 4 shows a column of images from FIG. 3 shot at the same view angle that is composed into a sequence of images in motion.

FIG. 5 shows a row of images from FIG. 3 shot in one rotation (10 images shown on top). When these images are stitched together, they form a panoramic view to cover a 360 degree field of view as shown below.

FIG. 6 shows an example of a micro air vehicle according to the invention.

FIG. 7 is a block diagram of the major components of a rotary system according to some embodiments.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a rotary system for capturing and displaying in real time spherical moving images of the surrounding scene in any resolution preferably in high resolution. The rotary system comprises a camera, an image buffer, a rotary, a controller and a display unit. The camera comprises an image sensor, an image sensor engine and lens where the camera rotates continuously around an axis. The rotation speed is typically at least 120 rpm to speeds of up to 2,880 rpm or more in order to take numerous still images shots (captures) in a fraction of a second. The invention enables to display the full sphere or any number of portions of it in any number of display devices in real time. The term “real time” as used herein means a response time from capturing an image to displaying the image in the order of a fraction of a millisecond.

The camera is capable of taking a large number of images per second. One camera used for testing is capable to capture up to 1,200 frames per second. Typically, the camera is mounted on a rotary, such as a transportable pod with variable rotation speeds. One configuration tested rotated at a rotation speed of up to 1,440 rounds per minute. Tables 2 and 3 describe several configurations for day and night image capture.

An image sensor is a device that converts an optical image into an electronic signal. As example: a charge-coupled device (CCD) or a complementary metal-oxide-semiconductor (CMOS) active pixel image sensor. It is used mostly in digital cameras and other imaging devices.

The rotary can use any rotation mechanisms known in the industry such as a rotation motor, though other rotation mechanisms are know, for example, using air or fluids and all known and future rotation mechanisms are considered to be part of the invention.

The invention can work in real time mode, wherein the images captured are buffered, processed into moving images and displayed immediately. A real time buffer for holding the captured images can be the memory of a video card, the memory of a camera, memory of an image sensor, the memory on a controller, the memory of a real-time processing unit or any combination thereof. Alternatively, the image buffer can be a transfer link, such as data link or optical link, communicating directly between the camera and display unit. Such memory can be both volatile and/or non volatile memory. It is also possible to use memories on different locations.

In addition, the system can use a permanent storage for storing the captured images. The permanent storage may be one or more storage devices such as hard drives, typically large enough to save minutes if not hours of recordings. When the display unit is working with a permanent storage, the display unit can perform search and retrieval operations using the captured images in the permanent storage, and process any array of stored images into moving images.

The term “displaying moving images” as referred herein means that a sequence of still images is displayed on a display device (screen), which for the user looks the same as watching a video or a movie. The difference is that the data is not in a video format, such as MPEG, but the data is a plurality of still images displayed rapidly.

The system's controller unit controls the rotary's speed and the camera's image capture. There can be a single controller unit for both the camera and the rotary or separate controllers can be used. The controller unit controls the image capture of the camera via a trigger. A trigger initiates the capture of single or multiple images of a camera by analyzing the signals of its sensor. Any trigger in the industry can be used with the invention.

In some embodiments, the trigger is not affected by the speed of rotation. It uses an absolute angle position around the rotating axis. At this location the camera receives a pulse which gives it a signal to capture an image at the location of the receipt of the signal. As the location is absolute, images are taken always at exactly the same absolute angles. Using such trigger methods is useful in order to avoid an effect of sweeping away of moving images. The trigger is also able to action other devices then the camera, for example, lighting devices.

Examples of image triggers that can be used:

Optical sensor (e.g., manufactured by Omron Electronics of 1 East Commerce Drive, Schaumburg, Ill. 60173 U.S.A.). Electro-optical sensors are electronic detectors that convert light, or a change in light, into an electronic signal. They are used in many industrial and consumer applications, for example, lamps that turn on automatically in response to darkness.

Hall effect based image triggers. The Hall effect is the production of a voltage difference (the Hall voltage) across an electrical conductor, transverse to an electric current in the conductor and a magnetic field perpendicular to the current.

The display unit is responsible for displaying the images in the image buffer in a moving images view in real time according to different criteria and parameters. For example, the display unit can simultaneously open any number of high-resolution views of the spherical moving picture. In one example, more than 30 different views were opened. The display unit can enable the user to zoom in and out of any view.

When working with images in an image buffer, all user operations such as change views, zoom in, zoom out, pan, tilt are done in real time. The system captures the entire surroundings but the user chooses to view a region of interest from within the surroundings. Regions of interest can have different sizes, where each user defines the size and location of the region of interest within the surroundings. The user can shift the region of interest to different locations within the captured surroundings. In real time mode, the information not viewed by the user (if not recorded) is lost, since new images overwrite older images in the image buffer.

When the system comprises a permanent storage capable of recording minutes or hours of recordings (recorded time is unlimited theoretically and depends on the storage size and size of images captured), the system can perform all the operations as if it was in real time mode. The difference being that instead of capturing new images, the display unit would use the captured images from the permanent storage. Any combination, number, location and size of regions of interest can be created/displayed in permanent storage mode, exactly like in real time mode.

One advantage of the rotary system of the invention is that it can generate multiple (and different) views of the surroundings, a useful feature whenever one needs the ability to look in several different directions at the same time, or quickly change directions. The system is able to deliver an unlimited number of different views to different users simultaneously with a single capture device, without losing image information. The different views can be generated by the display unit to a single screen where the user chooses each time which view to watch or alternatively several screens (including geographically distant screens) can be used where each user can choose on each screen which view to watch.

It is important for most image capture systems to be able to work effectively both at day and at night. The rotary system of the invention enables the integration of night and day vision into the same system. Two different image sensors can be mounted into the same camera, a day image sensor and a night image sensor. This is made possible because the image data of both sensors can be transmitted through one data connection—possible due to the control of the trigger. The trigger signals can be split among image sensors to provide signals to both the day and the night image sensors as required, whereas the day and the night image sensor receive alternating signals from the image trigger.

In some embodiments, instead of all trigger signals per rotation going exclusively to a single image sensor, the trigger signals can be split in a way where the first signal goes to the day image sensor, the second signal to the night image sensor, the third signal to the day image sensor, and so forth. In this example, the data transmission would be split between the day and the night image sensors. Once the data transmission would be used to transmit the day image, and subsequently it would be used to transmit the night image, and so forth. A user can thus view simultaneously both day and night captures or only view one state.

The system of the invention can deliver any number of spherical views as a sequence of digital still images which are rendered to a moving images view in real time. A “spherical view” as defined herein refers to view of 360 degrees vertically by up to 360 degrees horizontally and more. A sphere can be defined as the set of points in three-dimensional space which are at distance r from a fixed point of that space, where r is a positive real number called the radius of the sphere. The fixed point is called the center and is not part of the sphere itself.

The rotary system of the invention can capture a large number of images in a fraction of a second, where the all the captured images—depending on the resolution of the image sensor—can have a very high resolution. The rotary system of the invention does not have blind angles and is not a conventional panorama, fisheye or straw view. Due to the spherical nature of the moving pictures, it is possible to shoot a moving picture of the whole surroundings in real time.

The display unit is able to simultaneously generate any number of moving images display of regions of interest (sections) out of the captured images in the image buffer and/or permanent storage, which can be displayed in different screen windows and in different display units/devices.

It should be noted that the system of the invention does not require any stabilization mechanisms such as a gimbal or gimbal ring (typically devices consisting of two rings mounted on axes at right angles to each other so that an object, such as a ship's compass, will remain suspended in a horizontal plane between them regardless of any motion of its support). The system of the invention does not require such (or other) stabilization means in view of the constant rotation, rapid rotation speed, use of still images, fast image capture rate per second and the fact that images are captured always through the same sensor, all these and other factors enable the system of the invention to work well without added stabilization means.

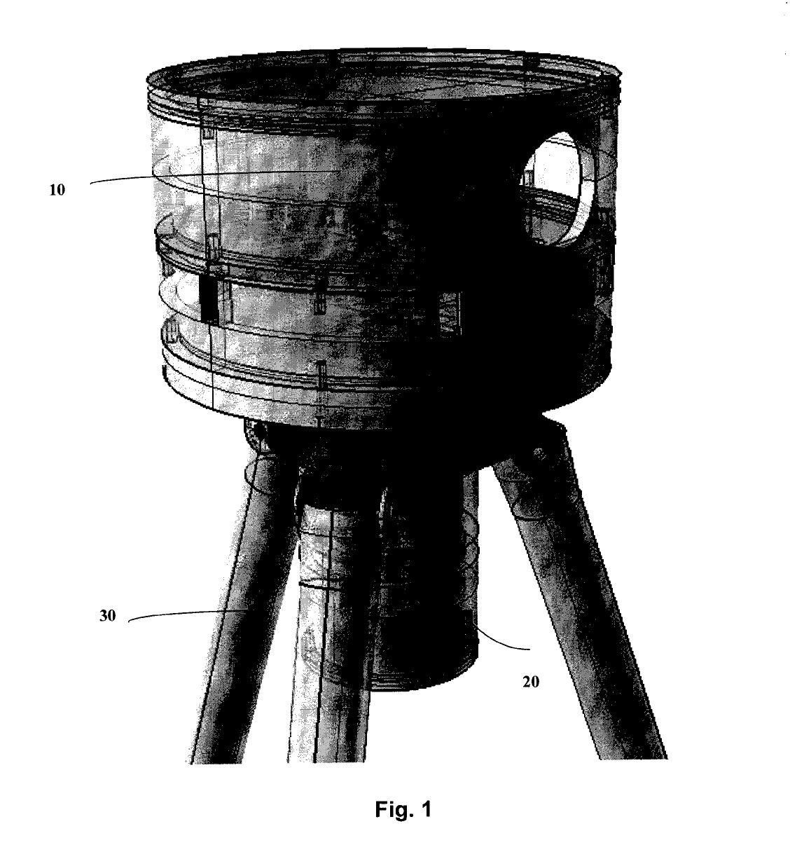

FIG. 1 shows an example of a rotary system of the invention. A camera 10 is attached to a rotary 20 mounted on a tri-pod 30. Other variations of the system can be mounted on top of an asset, vehicle, vessel or aircraft.

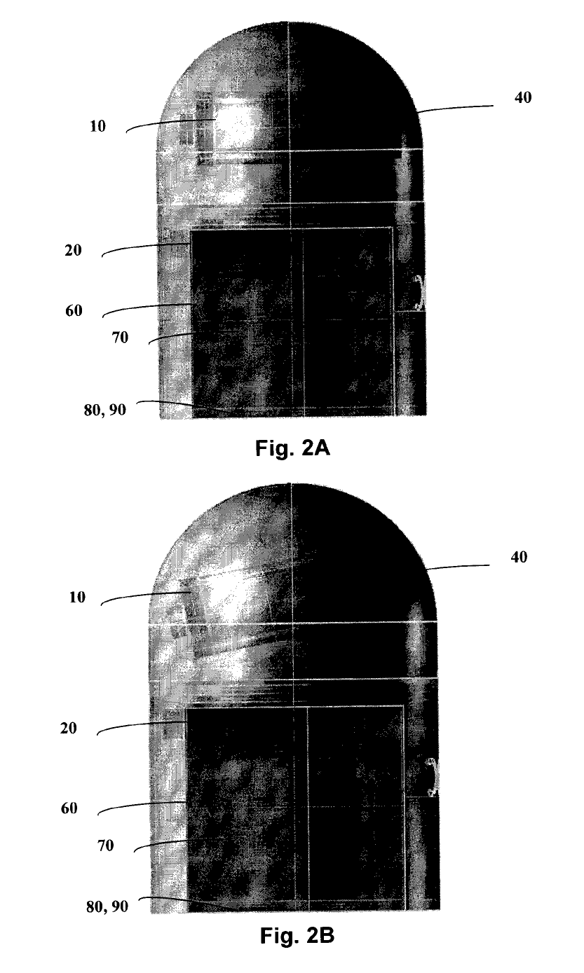

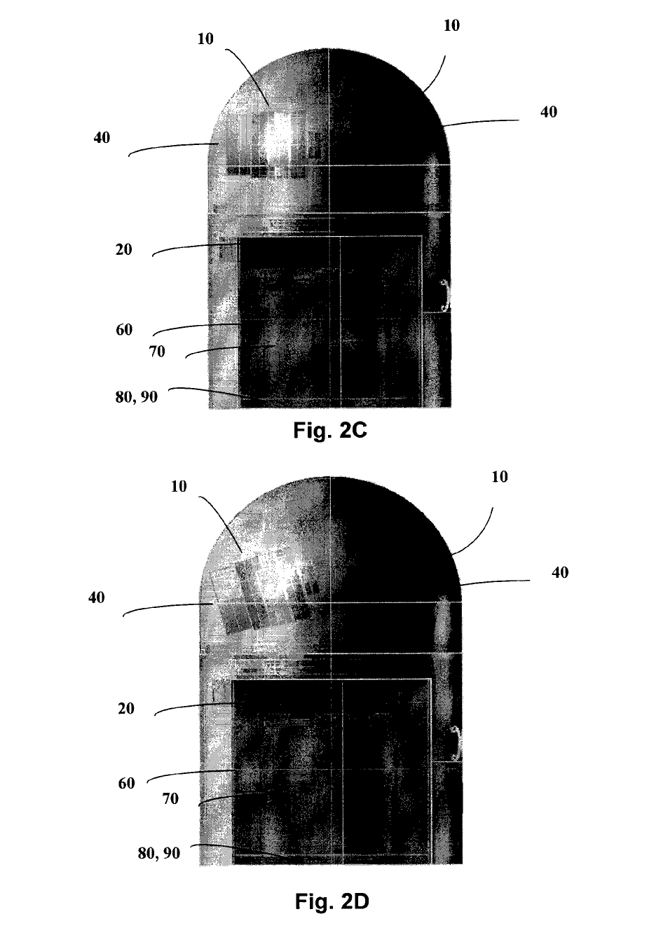

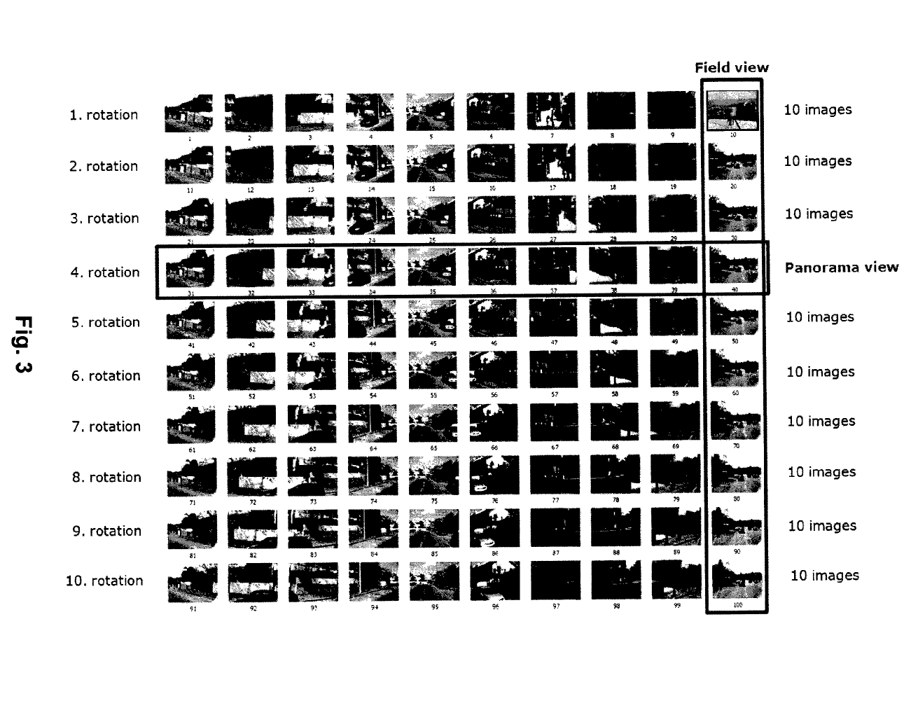

FIGS. 2A-2D show four examples of miniature standalone system. FIG. 2A shows a system with a single camera 10; FIG. 2B shows a system with a single camera 10, wherein the camera is in a tilted position; FIG. 2C shows a system with a two cameras 10, for example, when one camera 10 is used for day image capture and the other camera 10 is used for night image capture; and FIG. 2D shows a system with a two cameras 10, wherein the cameras 10 are in a tilted position. The rotating platform is inside an outer case which can be fixed to an asset or vehicle. The camera 10 and lens 40 (or set of lenses 40) are coupled to a rotary 20 placed inside a chassis 60. Also shown is a slip ring 70, as an example of a power and data transmission unit. A slip ring 70 (in electrical engineering terms) is a method of making an electrical and data connection through a rotating assembly. Slip rings 70 are also called rotary electrical interfaces, rotating electrical connectors, collectors, swivels, or electrical rotary joints. A slip ring 70 is a rotary coupling used to transfer data as well electric current from a stationary unit to a rotating unit. Either the brushes or the rings are stationary and the other component rotates. Another example of a power and data transmission unit would be using contactless rotary joints for transmitting power and data between stationary and rotating frames without the use of conventional slip rings or brushes. In such power and data transmission unit there is no physical contact between the rotating and fixed parts of the unit.

On the bottom are shown the locations for the power connector 8 and data connector 90. A power connector 80 is used when the power source used is an external power source, for example, in the vehicle or asset. The data connector 90 is used to communicate with the controlling unit for controlling the rotary's speed and angle (tilt) and for controlling the camera's image capture in terms of speed, view angle and other image capture parameters such as zoom, aperture speed, exposure etc. The data connector 90 is also used for saving images taken to the permanent storage, when the storage is external. When the storage is internal, the display unit accesses the storage via the data connector 90.

The following configuration enables the system to rotate at speeds of up to 2,880 rounds per minute (rpm).

Manufacturer of image sensor and engine: Prosilica GB660C

Resolution: VGA 659×493 pixels

Pixel size: 5.6×5.6 μm

Optical size: ¼″

Interface: Gigabit Ethernet

Lens: 5 mm

Trigger: 10 signals per round

Rotation speed: 600 rounds per minute

Capture speed: 100 images per second

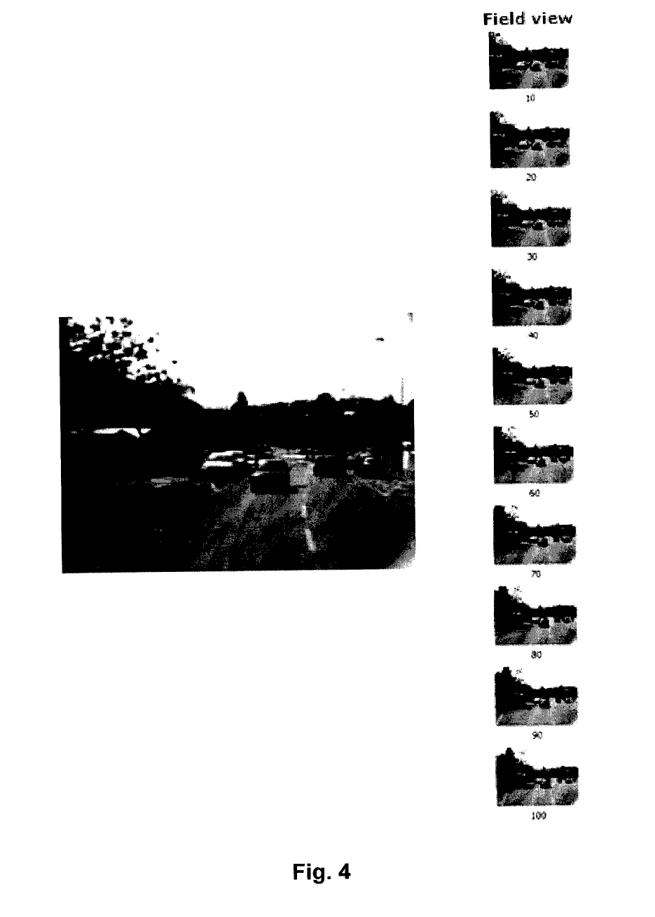

FIG. 3 shows the images captured in a system configured to capture 100 images per second at 600 rpm. We obtain a stream of pictures which can then be processed by the display unit. FIG. 3 shows how ten images per rotation are generated for viewing up to ten field views simultaneously. After one second, the rotary system has completed ten rotations and shot 100 images.

Every line in FIG. 3 marked “1. rotation” to “10. rotation” contains the 10 images captured in that rotation. Every images is captured with a different view angle. It is best that every images overlaps with the preceding and following images in order to be able to generate a panoramic view of that rotation. The overlap can be very small, for example, about 5% or less of each images.

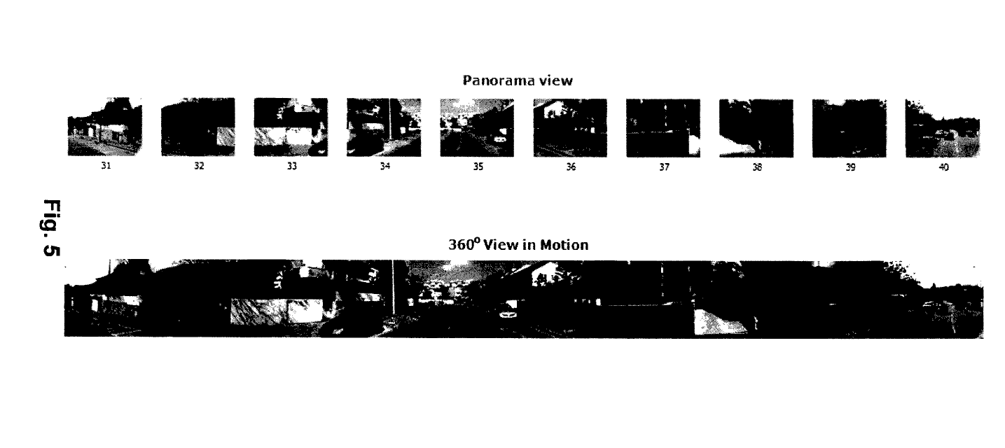

Each row in FIG. 3 contains all the images captured with the same view angle (the 10^{th} row is marked “field view”). When the images in a row are displayed continuously (in this example in a display rate of 10 frames per second), they create a moving images view the scene in that specific view angle as shown in FIG. 4.

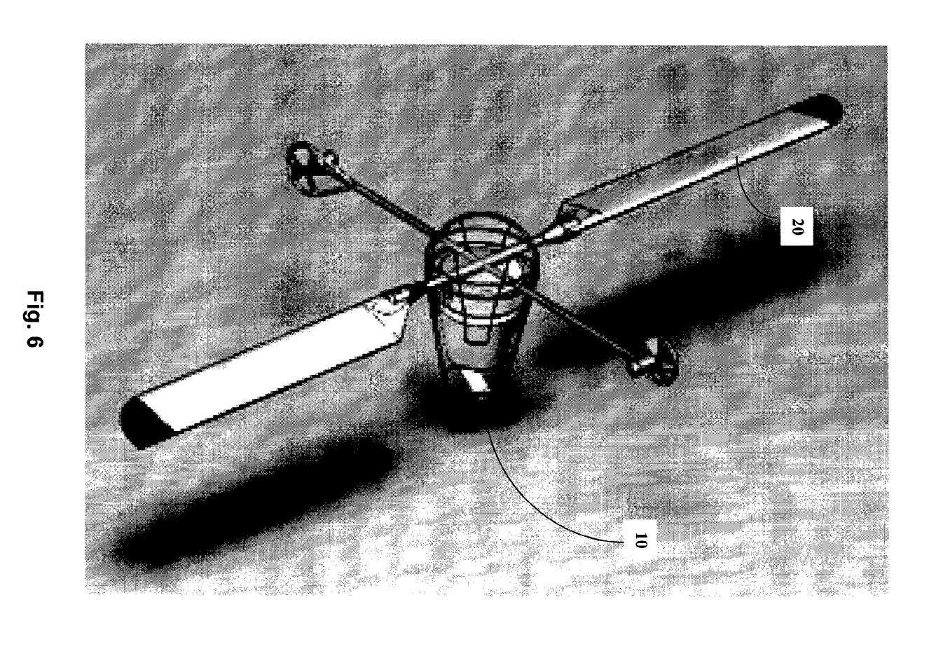

FIG. 5 shows how all images taken in a single rotation numbered 31 to 40 (shown as one line in FIG. 3) are rendered into a view (bottom picture) showing a panoramic section of the surroundings generated on the fly. The resulting image sequence is displayed as a moving 360 degree view (moving images view) of the scene. As each image is shot at high resolution, users can digitally zoom in into the movie.

An imaging pod can be defined as a specially designed container for a rotary system or several rotary system combinations (day & night) (e.g., video camera, photo camera, day vision camera, night vision camera (infrared, short-wave infrared (SWIR) camera using wavelengths from 0.9 to 1.7 microns). Such a pod is attached to the outside of a vehicle, vessel or aircraft (manned or unmanned).

The rotary system of the invention can be built either as an integrated subsystem or as a standalone system.

As an integrated subsystem, it is integrated into imaging systems of third parties. Such an imaging pod includes all hardware, software and interfaces necessary to communicate with the imaging systems, and with third-party software and control centers. It can be incorporated in a range of applications: for vehicles, airborne use, inside buildings, underground, on the ground, and maritime.

The standalone system represents an imaging pod, which can be deployed without further integration. It comes with all necessary software interfaces and connectivity to control centers and imaging applications. For example, it can be used for traffic surveillance and other urban surveillance uses as homeland security, robotics, etc.

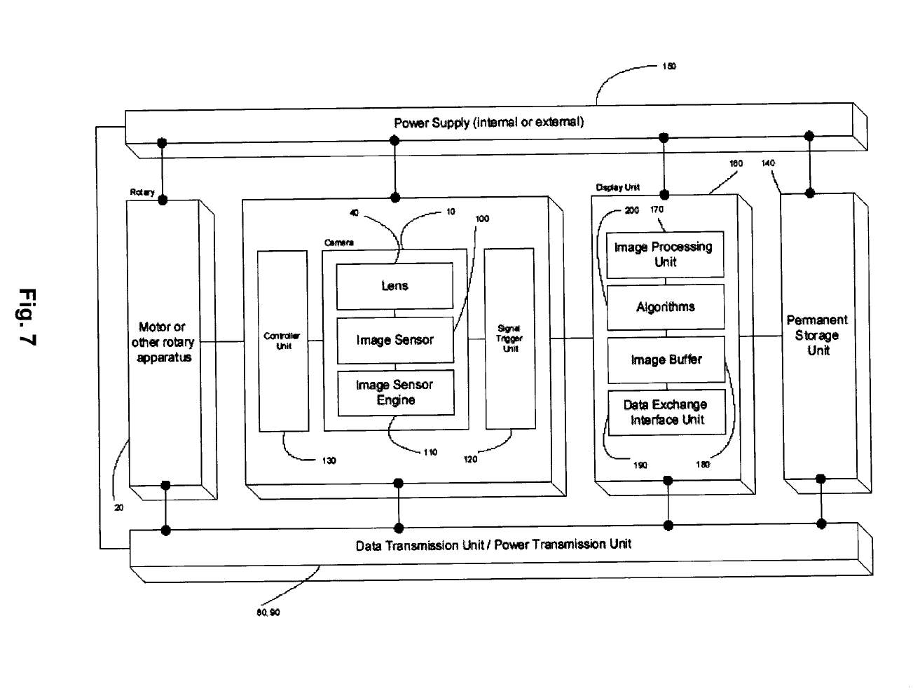

FIG. 6 shows a preliminary prototype design for a Micro Air Vehicle (MAV). The rotary system of the invention has been used to build an airframe around the image generation technology of the invention, which uses the rotation for propulsion and stabilization in the application as an Unmanned Arial Vehicle (UAV). The result is a camera 10 which is an airframe in itself, combining all the advantages of a micro-size UAV with the spherical viewing nature according to the invention. It represents a “third eye”, an instant extension of vision to see in places which could otherwise not be reached.

The system will be comprised of the following components:
Multi-use airframe with auto-navigation.
Base station with flight control.
Vision system: glasses, head-up display, screen, etc.
Optional third-party payloads: ammunition, image sensors, etc.

The single major competitive advantage is its small size combined with advanced image capturing 10 and transmission technology, which makes it ideally suited for deployment in urban environments, including its use inside and around buildings.

Design goals of the MAV include but are not limited to:
Operating radius: 1,000 and more meters.
Flight time: minimum 30 minutes.
Night vision capable.
Autonomous mission management.
Collision avoidance.
Flight in swarms on mutual mission.
Intelligent system health monitor.
Quick deployment within seconds.
Low noise.
Vertical take off and landing (VTOL).

Reference is now made to FIG. 7 showing a block diagram with the major components of a rotary system, according to some embodiments. A camera 10 comprising an image sensor 100, an image sensor engine 110, and lens 40 is driven (controlled) by a controller unit 130 and a signal trigger unit 120. The image sensor engine 110 (AKA image processing engine or image processor) operates the image sensor 100 in order to capture an image.

The camera 10 is rotated around its axis by a rotary 20. The rotary 20 typically comprises a rotation motor or other rotation mechanisms (like air or fluids based rotaries) available in the industry.

The display unit 160 is in charge for processing and displaying in real time the captured images. The captured images are held in an image buffer 180 shown here to reside in the display unit 160 though the image buffer 180 can reside in other locations such as the camera 10. The display unit 160 comprises an image processing unit 170 and algorithms 200 in order to process and display the captured images. Such processing can be, for example, displaying images according to a specific order, removing overlapping zone between two images, zooming on an image, streaming an array of still images as moving images view (seen by the user as a video) etc. A data exchange interface unit 190 enables the system to communicate with third party system, for example, in order to send the moving images for display on third party display units. Optionally, one or more permanent storage units 140 can be connected to the system in order to record (save) the captured images. All components receive power from a power supply 150 that can be internal (like batteries) or external (external electricity source) or both. The power transmission unit 90 is connected to the power supply 150 and is responsible for transferring power to the different components of the system and in particular to the rotating components (where a cable cannot be used). The data transmission unit 80 is also connected to the power supply 150 in most cases.

Competition Overview—There are different technologies which may seem to have similar features. All competing technologies are based on either multiple video cameras or special lenses. Table 1 shows how these technologies compare:

TABLE 1
Comparison of Technologies

| | | | | PANORAMIC |
|---|---|---|---|---|
| | | | | CAMERA |
| | | | | using special |
| | SYSTEM | | MULTIPLE | lenses (e.g., |
| | OF THE | VIDEO | VIDEO | omni- |
| | INVENTION | CAMERA | CAMERAS | directional) |
| View angle | Variable | Fixed | Up to 360° | 360° |
| (horiz.) | 0°-360° | | | |
| View angle | Variable | Fixed | Fixed | <180° |
| (vert.) | 0°-360° | | | |
| Number of | | 1 | 1 | 1 |
| views | | | | |
| Number of | Unlimited | 1 | 1 | 1 |
| users | | | | |
| Optical | None | None | Low | Medium |
| distortion | | | | (needs |
| | | | | “dewarping”) |
| Resolution | Very high | Low | High | Low |
| of detail | | | | |
| Price level | Medium | Low | Very high | High |
| Application | Wide | Wide | Narrow | Narrow |
| range | | | | |
| Complexity | Low | Low | High | High |
| of | | | | |
| integration | | | | |

The following configurations illustrate some examples of hardware configurations that can be used.

TABLE 2
Day Vision Configurations

| | | | | | | | Rotation | Image |
|---|---|---|---|---|---|---|---|---|
| Camera | | | Optical | | | | Speed | Capture |
| Model | Resolution | Pixel Size | Size | Interface | Lens | Trigger | (RPM) | Speed (fps) |
| Dalsa | VGA | 7.4 × 7.4 μm | ⅓″ | Gugabit | 5 mm, | 10/round | 360 | 60 |
| Genie | 640 × 480 | | | Ethernet | C mount | | | |
| HM640 | | | | over Coax | | | | |
| Dalsa | VGA | 7.4 × 7.4 μm | ⅓″ | Gugabit | 5 mm, | 10/round | 720 | 120 |
| Genie | 640 × 480 | | | Ethernet | C mount | | | |
| HM640 | | | | over Coax | | | | |
| Dalsa | VGA | 7.4 × 7.4 μm | ⅓″ | Gugabit | 12 mm, | 20/round | 360 | 60 |
| Genie | 640 × 480 | | | Ethernet | C mount | | | |
| HM640 | | | | over Coax | | | | |
| Dalsa | VGA | 7.4 × 7.4 μm | ⅓″ | Gugabit | 12 mm, | 20/round | 720 | 240 |
| Genie | 640 × 480 | | | Ethernet | C mount | | | |
| HM640 | | | | over Coax | | | | |
| Dalsa | VGA | 7.4 × 7.4 μm | ⅓″ | Gugabit | 5 mm, | 10/round | 1440 | 240 |
| Genie | 640 × 480 | | | Ethernet | C mount | | | |
| HM640 | | | | over Coax | | | | |
| Dalsa | VGA | 7.4 × 7.4 μm | ⅓″ | Gugabit | 5 mm, | 10/round | 1800 | 300 |
| Genie | 640 × 480 | | | Ethernet | C mount | | | |
| HM640 | | | | over Coax | | | | |
| Procilica | VGA | 5.6 × 5.6 μm | ¼″ | Gugabit | 5 mm, | 10/round | 360 | 60 |
| GB660C | 659 × 493 | | | Ethernet | C mount | | | |
| | | | | over Coax | | | | |
| Procilica | VGA | 5.6 × 5.6 μm | ¼″ | Gugabit | 5 mm, | 10/round | 720 | 120 |
| GB660C | 659 × 493 | | | Ethernet | C mount | | | |
| Adimec | 1024 × 1024 | 5.5 × 5.5 μm | 1″ | CoaXPress | 25 mm, | 10/round | 720 | 120 |
| QUART | | | | | C mount | | | |
| Z Q-4A180 | | | | | | | | |
| Adimec | 2048 × 2048 | 5.5 × 5.5 μm | 1″ | CoaXPress | 25 mm, | 10/round | 360 | 60 |
| QUART | | | | | C mount | | | |
| Z Q-4A180 | | | | | | | | |

TABLE 3
Night Vision Configurations

| | | | | | | | Rotation | Image |
|---|---|---|---|---|---|---|---|---|
| Camera | | | Spectral | | | | Speed | Capture |
| Model | Resolution | Pixel Size | response | Interface | Lens | Trigger | (RPM) | Speed (fps) |
| FLIR | 320 × 256 | 30 × 30 μm | 0.9-1.7 μm | Gugabit | 25 mm | 20/round | 360 | 60 |
| SC2500 - | | | | Ethernet | | | | |
| SWIR | | | | over Coax | | | | |
| FLIR | 320 × 256 | 30 × 30 μm | 3.0-5.0 μm | Gugabit | 25 mm, | 20/round | 360 | 60 |
| C4000 - | | | | Ethernet | Germanium | | | |
| Could | | | | over Coax | | | | |
| system | | | | | | | | |

Many alterations and modifications may be made by those having ordinary skill in the art without departing from the spirit and scope of the invention.

Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A rotary system for capturing images of the surroundings, comprising:
(i) a camera comprising an image sensor, image sensor engine and lens for capturing a plurality of still images per second;
(ii) an image buffer for holding the captured plurality of still images;
(iii) a rotary connected to the camera for rotating the camera around its an axis;
(iv) a controller unit for controlling the rotary's rotation speed and for controlling the camera's image capture;
(v) a slip ring; and
(vi) trigger unit for activating said camera,
wherein, the rotating camera takes a plurality of still images, each still image taken in a predetermined view angle and stored in said image buffer, such that the display unit can display from the images in the image buffer one or more views of the surrounding in a moving images view.

2. The rotary system according to claim 1, wherein the images captured in one rotation of the rotary system cover the entire panorama of the surroundings in a field of view of up to 360 degrees vertically by up to 360 degrees horizontally.

3-5. (canceled)

6. The rotary system according to claim 1, wherein placing the images taken side by side in chronological order, produces in real time a panoramic view of the surroundings after compensating for overlaps in sequential image captures.

7. The rotary system according to claim 1, wherein the series of still images taken with a plurality of view angles, are displayed on one or more display devices.

8. The rotary system according to claim 1, wherein the rotary rotates with variable rotation speeds.

9. The rotary system according to claim 1, wherein the camera or the rotary or both can tilt.

10. (canceled)

11. The rotary system according to claim 1, wherein the display unit enables to zoom in a still image or a stream of moving images.

12. (canceled)

13. The rotary system according to claim 1, wherein the image buffer is a transfer link communicating directly between the camera and display unit.

14. The rotary system according to claim 1, further comprising a permanent storage for saving the captured images.

15. The rotary system according to claim 14, wherein the system can perform search and retrieval operations using the saved images in the permanent storage.

16. The rotary system according to claim 15, wherein the search and retrieval operations comprise: pausing a moving image sequence, resuming to real time viewing, rewinding a moving image sequence, advancing a moving image sequence or any combination thereof.

17. A rotary method for capturing moving images of the surroundings, the method comprising the steps of:
(i) capturing a plurality of still images per second by a camera comprising an image sensor, an image sensor engine and lens;
(ii) holding said plurality of still images in an image buffer;
(iii) connecting the camera to a rotary for rotating the camera around an axis;
(iv) controlling the rotary's speed and controlling the camera's image capture by a controller unit;
(v) transferring data and electric current via one or more slip rings;
(vi) activating said camera via at least one signal trigger unit
wherein, the rotating camera takes a plurality of still images, each still image taken in a predetermined view angle and held in said image buffer such that the display unit can display in real time one or more views of the surrounding in a moving images view.

18. The rotary method according to claim 17, further comprising the step of saving the captured images in a permanent storage.

19. The rotary method according to claim 18, further comprising the step of performing search and retrieval operations by the system using the saved images in the permanent storage, and processing any array of stored images into moving images.

20. The rotary method according to claim 17, further comprising the step of processing and displaying the captured images by a display unit.

21. The rotary system according to claim 1, wherein multiple, different views of the surroundings are generated to be displayed on one or more display units.

22. The rotary system according to claim 1, further comprising a display unit for processing and displaying the captured images in said image buffer.

23. The rotary system according to claim 1, further comprising a display unit for processing and displaying in real time the captured images in said image buffer.

24. The rotary system according to claim 1, further comprising a day image sensor or a night image sensor or both.

25. The rotary system according to claim 1, further comprising a night vision camera using infrared or short-wave infrared.
